(19) United States
(12) Patent Application Publication
(10) Pub. No.: US 2016/0104060 A1
(43) Pub. Date: Apr. 14, 2016

(54) PHOTO IMAGING SYSTEM AND METHOD

(71) Applicant: Craig GEIGER, Copiague, NY (US)

(72) Inventor: Craig GEIGER, Copiague, NY (US)

(73) Assignee: Graphix Solutions, Copiague, NY (US)

(21) Appl. No.: 14/511,704

(22) Filed: Oct. 10, 2014

(51) Int. Cl. G06K 15/02

(52) U.S. Cl. CPC G06K 15/021

(57) ABSTRACT

A photo imaging system and method for forming an image in porous material is provided. The photo imaging system includes a printing device configured to travel over the porous material for printing a photo on a printing surface area of the porous material and at least one curing device configured to travel over at least the printing surface area of the porous material to perform a curing process.

### BACKGROUND OF THE INVENTION

1. Field of the Invention

The present invention relates generally to a photo imaging system and method, and more particularly, to a photo imaging system and method for forming an image in porous material.

2. Description of the Related Art

Stone such as marble, granite, quartz, travertine limestone, sandstone, metamorphic stone, slates, and serpentine are used for many purposes including counter tops, memorial plaques, gravestones, door sills, decorative inlays and the like.

In some applications, it is desired to impregnate the stone with a design or image. For example, in the instance where the stone is used for a memorial plaque, it may be desirable to impregnate the stone with an image of the deceased (or the deceased loved ones). Conventional systems and methods configured to impregnate a stone with such an image produce limited results with superficial images that wear with time.

Therefore, there exists a need for a photo imaging system and method for forming an image in porous material.

### SUMMARY OF THE INVENTION

The present invention has been made to address the above problems and disadvantages, and to provide at least the advantages described below.

In accordance with an aspect of the present invention, a photo imaging system for forming an image in porous material is provided. The photo imaging system includes a printing device configured to travel over the porous material for printing a photo on a printing surface area of the porous material and at least one curing device configured to travel over at least the printing surface area of the porous material to perform a curing process.

In accordance with another aspect of the present invention, a method for forming an image in porous material is provided. A porous material is first supported on a printing device configured to travel over the porous material for printing a photo thereon. Thereafter, the photo is printed on a printing surface area of the porous material. Then, the printed photo is cured with at least one curing device configured to travel over at least the printing surface area of the porous material.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is block diagram of a photo imaging system for forming an image in porous material, according to an embodiment of the present invention;

FIG. 2A is a diagram illustrating the photo imaging system positioned over a porous material, according to an embodiment of the present invention;

FIG. 2B is side view of the porous material having a photo printed thereon;

FIG. 3 is a flowchart illustrating a method for forming an image in a porous material, according to an embodiment of the present invention; and

FIG. 4 is diagram of a photo printed on a porous material using the photo imaging system and method, according to an embodiment of the present invention.

### DETAILED DESCRIPTION OF EMBODIMENTS OF THE PRESENT INVENTION

Various embodiments of the present invention will now be described in detail with reference to the accompanying drawings. In the following description, specific details such as detailed configuration and components are merely provided to assist in the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

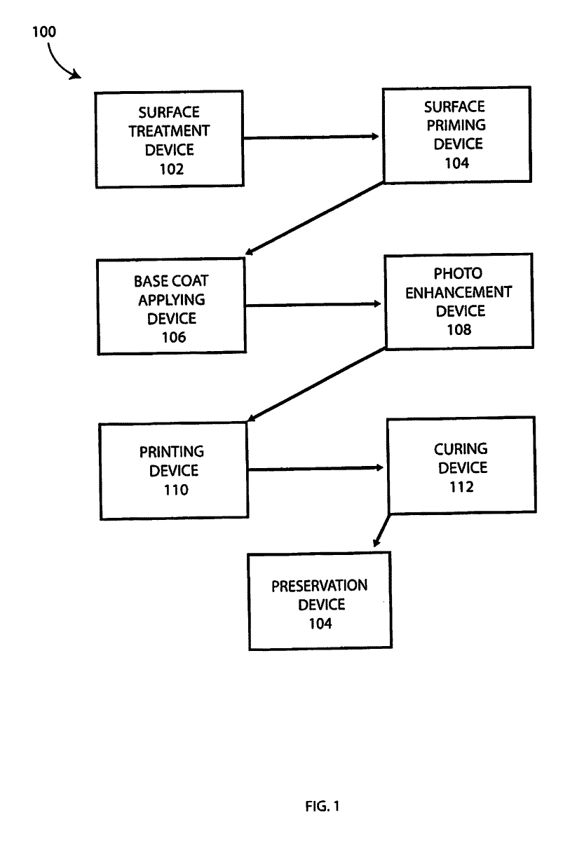

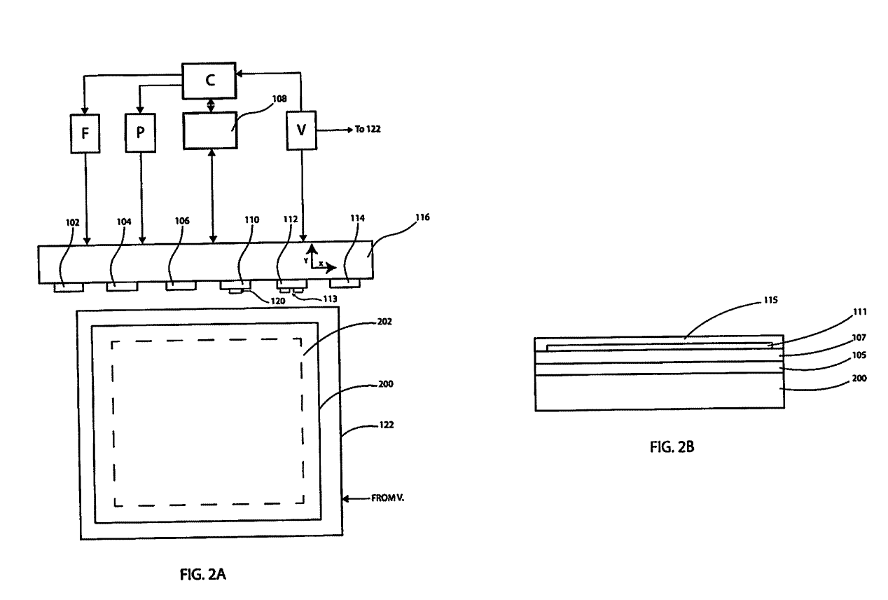

FIG. 1 is a block diagram of photo imaging system 100 for forming an image in porous material 200, and FIG. 2A is a diagram illustrating the photo imaging system 100 positioned over the porous material 200, according to an embodiment of the present invention.

As illustrated in FIGS. 1 and 2A, the photo imaging system 100 includes a surface treatment device 102, a surface priming device 104, a base coat applying device 106, a photo enhancement device 108, a printing device 110, a curing device 112, and a preservation device 114. For illustrative purposes, these devices are shown supported on a motorized manifold 116 (shown schematically in FIG. 2A) that may be in operative communication with a fluid source F, which is configured to provide one or more types of fluid (e.g., water, air, etc.), a paint source P, which is configured to provide one or more types (or colors) of paint (or coating materials), and a vacuum source V. The fluid source F, paint source P, and vacuum source V may be in operative communication, via one or more supply lines (not shown), with one or more of the devices of the photo imaging system 100, as will be described in greater detail below.

One or more controllers C are in operative communication with the manifold 116 and are configured to control the overall operation of the photo imaging system 100, fluid source F, paint source P, and vacuum source V. For illustrative purposes, one controller C is shown.

As can be appreciated the manifold 116 can be omitted and the surface treatment device 102, the surface priming device 104, the base coat applying device 106, the photo enhancement device 108, the printing device 110, the curing device 112, and the preservation device 114 may be embodied as separate manually operated devices.

In accordance with embodiments of the present invention the photo imaging system 100 uses the above devices to print a photo on one more porous materials including, but not limited to, marble, granite, quartz, travertine, limestone, sandstone, metamorphic stones, slate, serpentine. Other porous material, which the photo imaging system 100 may be used to print on, may include man-made stone types that mix natural stones with cement and additives of stone chips. Such stone types may include cultured stones, terrazzo stones, agglomerate, and/or conglomerate stones.

The surface treatment device 102 is configured to treat the porous material 200 prior to printing a photo on the porous material 200. More particularly, prior to printing on the porous material 200, the surface treatment device 102 is configured to remove dirt/debris from a printing surface 202 (illustrated by phantom lines in FIG. 2A) of the porous material 200. The surface treatment device 102 may use a pressure washing treatment process and/or an acid wash process to remove dirt/debris from a printing surface 202. In such embodiments, the surface treatment device 102 receives pressurized water/acid (and/or other fluid, e.g., air) from the fluid source F and applies this fluid to the printing surface area 202 to remove dirt/debris therefrom.

The surface treatment device 102 may include a bristle brush or other suitable instrument (not shown) that may be used to remove any dirt/debris that was not removed via the pressure washing process and/or acid wash process. Moreover, the surface treatment device 102 may use the vacuum capabilities of the vacuum source V to remove any dirt/debris that was not removed via the pressure washing process, acid wash process, and/or the brushing process.

After the dirt/debris has been removed from the printing surface area 202, the surface priming device 104 may be used to apply one or more suitable primers 105 to the printing area surface 202 (FIG. 2B). The primer 105 assists with the ink adhesion. The primer 105 can be applied via a brush (not shown), which may be provided on the surface priming device 104. Alternatively, the primer 105 can be spray primer, in which case the surface priming device 104 may be provided with a spray nozzle (not shown). In either instance, the surface priming device 104 receives the primer 105 from the paint source P and applies the primer 105 to the printing surface area 202. Depending on the type and/or amount of primer 105 used, the primer 105 may be allowed approximately 6-7 hours to dry. Factors such as temperature, weather, etc. may increase or decrease the dry time.

After the primer 105 is properly dried, the base coat applying device 106 is used to apply a base coat of paint 107 (FIG. 2B) to the printing surface area 202. The base coat of paint 107 is used to achieve an accurate color reproduction of the photo on the printing surface area 202. Any color may used for the base coat of paint 107; however, it has been found that a concrete/stone white paint works especially well in obtaining an accurate reproduction of the photo.

The base coat applying device 106 may be provided with a brush or spray nozzle to apply the base coat of paint 107, which is also allowed 6-7 hours to dry. Factors such as temperature, weather, etc. may increase or decrease the dry time.

The photo enhancement device 108 is configured to enhance a photo to compensate for printing on the printing surface area 202 of the porous material 200. The photo enhancement device 108 may be embodied in various forms including, for example, known software applications, e.g., Photoshop®. The photo may be uploaded and/or downloaded, e.g., via the controller C, to the photo enhancement device 108 so that a user can format the photo to fit the printing surface area 202 of the porous material 200. For example, the photo enhancement device 108 can be used to increase and/or decrease a size of the original photo.

The photo enhancement device 108 may also be used to modify/alter various attributes of the photo. For example, pixel size, brightness, contrast, color, and the like may all modified/altered using the photo enhancement device 108 to produce a vivid color reproduction of the photo.

The photo enhancement device 108 may be used to add template designs, which are provided with the photo enhancement device 108 and/or stored in memory of the controller C, to a photo.

After the photo has been enhanced and the base coat of paint 107 has properly dried, the photo is ready to be printed on the printing surface area 202 of the porous material 200. To this end, the printing device 110 includes at least one inkjet printer head 120 and a flat bed printer vacuum bed 122 (or other suitable support structure).

The at least one inkjet head 120 dispenses ink, which may be ultra violet (UV) ink or other suitable ink, of at least one color onto the printing surface area 202 of the porous material 200. The at least one inkjet head may include up to sixteen Polaris® printing heads that travel along the x-axis and y-axis under the control of the controller C, which sends the print pattern saved in the photo enhancement device 108 to printing device 110.

In embodiments, the printing device 110 receives the photo from the photo enhancement device 108 (or the controller C) and is configured to uncouple from the manifold 116 and move relative thereto so that the at least one inkjet head 120 can dispense the ink onto the printing surface area 202 of the porous material 200. Alternatively, the controller C can be configured to send the print pattern directly to the manifold 116 which would then move the printing device 110 in accordance with print pattern, or, as noted above, the printing device 110 can be a separate component from the manifold 116. For example, the printing device 110 can be operably coupled to the flat bed printer vacuum bed 122 and movable relative thereto so that the at least one inkjet head 120 can dispense the ink onto the printing surface area 202 of the porous material 200.

The printing device 110 is configured to print the photo with a dots per inch (DPI) of up to 1440. The printing device 110 may use a six-color inkjet process which includes, but is not limited to, the colors cyan, magenta, yellow, black, light magenta, and light cyan.

The flatbed printer vacuum bed 122 is configured to support the porous material 200 in a substantially fixed orientation with respect to the at least one inkjet head 120 while the at least one inkjet head 120 dispenses ink over the printing surface area 202 of the porous material 200. With this purpose in mind, the flatbed printer vacuum bed 122 is in operative communication with the vacuum source V which provides suction to a bottom surface of the porous material 200 to maintain the porous material 200 in the substantially fixed orientation. Clamps, hooks and/or other devices may also be used to secure the porous material 200 to the flatbed printer vacuum bed 122. Rather than using the vacuum source V to provide suction to the flatbed printer vacuum bed 122, the flatbed printer vacuum bed 122 may include its own vacuum source.

Once the photo is printed on the printing surface 202 of the porous material (the printed photo is represented as reference number 111 in FIG. 2B), the curing device 112 is used to perform a UV curing process to cure the ink. More particularly, the curing device 112 includes two UV lights 113 that are configured to produce UV light up to 7500 watts; however, more than or less than two UV lights may be used. Shutters (not shown) on the curing device 112 open and close over the printing surface area 202 during the UV curing process thereby concentrating the UV light to only the printing surface area 202.

It is has been found that after the curing process, the inks used herein, as they are rated for use outdoors, maintain their original color for a minimum of five years. That is, the curing process mitigates the effects of fading, weathering, etc.

After the curing process is completed, the preservation device 114 may be used to preserve the printed photo 111; this also combats fading and weathering. The preservation device 114 is configured to apply a clear acrylic coating 115 (FIG. 2B) that can be either sprayed or brushed over the printed photo 111; it may prove advantageous to coat the entire surface area of the porous material 200. It has been found that approximately three hours of dry time is required to achieve a complete drying of the acrylic coating. The curing device 112 may be used to speed up the drying process.

While acrylic is described herein as the coating material, as it has a non-yellowing effect, the present invention is not so limited, as other types of coating materials may be used to preserve the photo. Regardless of the type of coating used to preserve the printed photo 111, the preservation process aids in resisting against water damage and further preserves the printed photo 111.

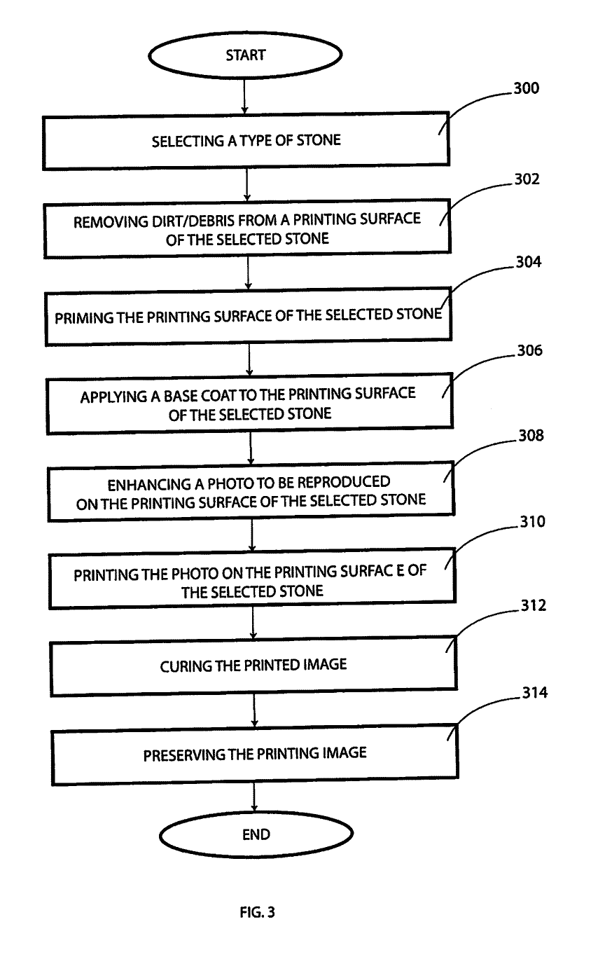

FIG. 3 is a flowchart illustrating a method for forming an image in porous material, according to an embodiment of the present invention. For illustrative purposes, it is assumed that a user wishes to have a photo of a family pet printed on a porous material 200. In this example, the family pet was a dog named “Buster.”

At step 300, a user selects a type of porous material 200 (e.g., natural stone) that the photo is to be printed on.

Thereafter, at step 302, the dirt/debris is removed from the printing area surface 202 using the surface treatment device 102, in a manner as described above. For example, the surface treatment device 102 may use the power washing process and the vacuum source V to remove dirt/debris from the printing surface area 202 of the porous material 200.

After the printing surface area 202 is thoroughly cleaned, the surface priming device 104 and the base coat applying device 106 may be used to apply one of the aforementioned primers 105 and base coats of paint 107, at steps 304, 306, respectively. In this example, the color white was used as the base coat.

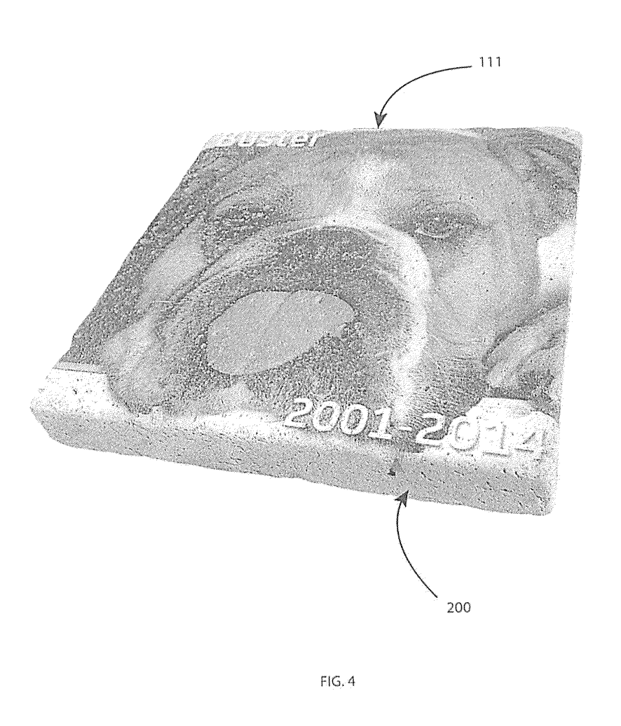

At step 308, the photo enhancement device 108 may be used to format the photo to fit the printing surface area 202 and/or modify various attributes of the photo, such as size. For example, the photo of “Buster” shown in FIG. 4 was formatted, e.g., slightly enlarged, such that the printed photo 111 covers the entire surface of the porous material 200. In addition, the photo enhancement device 108 was used to incorporate a template for the name “Buster” in an upper left hand corner of the printed photo 111 and a template for the lifespan of Buster, e.g., 2001-2004, in the lower right hand corner.

At step 310, the photo may be printed on the printing surface area 202 of the porous material 200, in a manner as described above.

Thereafter, at step 310, the ink is cured using the curing device 112, and, if a user desires to preserve the printed photo 111, at step 312, the preservation device 114 may used to apply the acrylic coating to the printed photo 111.

The photo imaging system 100 and method for forming an image in the porous material 200 described herein overcome the shortcomings of conventional systems and methods described above. That is, the photo imaging system 100 and method described herein are capable of printing a photo, on a porous material, that is crisp, clear, and less likely to be affected by fading and weathering.

As can be appreciated, any of the steps 302, 304, 306, 308, 312, and 314 can be omitted or skipped.

For example, if a porous material 200 (e.g., marble) has a relatively flat surface without pores that may collect dirt/debris, then the step 302 can be omitted. Moreover, depending on the type of porous material 200, the printing surface area 202 may not need to be coated with a primer. In such a case, the step 304 can be omitted. Likewise, if the porous material 200 includes a naturally white color, then the step 306 can be omitted. Or, if the photo and the printing surface area 202 are close in size, and enhancing the photo is not particularly important to a user, then the step 308 can be omitted.

In the case where all of the steps 302, 304, 306, 308, 312, and 314 are omitted, a user may simply perform step 310.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A photo imaging system for forming an image in porous material, the photo imaging system comprising:
a printing device configured to travel over the porous material for printing a photo on a printing surface area of the porous material; and
at least one curing device configured to travel over at least the printing surface area of the porous material to perform a curing process.

2. The photo imaging system according to claim 1, wherein the printing device includes at least one inkjet head that is configured to dispense ink of at least one color onto the printing surface area of the porous material.

3. The photo imaging system according to claim 2, wherein the at least one color is selected from the group of colors consisting of cyan, magenta, yellow, black, light magenta, and light cyan.

4. The photo imaging system according to claim 2, wherein the at least one inkjet head is configured to print the photo with a dots per inch (DPI) of 1440.

5. The photo imaging system according to claim 2, wherein the printing device includes a flatbed printer vacuum bed that is configured to support the porous material in a substantially fixed orientation with respect to the at least one inkjet head while the at least one inkjet head dispenses ink over the printing surface area of the porous material.

6. The photo imaging system according to claim 1, wherein the at least one curing device includes at least one ultra violet (UV) light source including at least one shutter that is configured emit UV light up to 7500 watts.

7. The photo imaging system according to claim 1, further comprising a surface treatment device that is configured to remove debris from the printing surface area of the porous material.

8. The photo imaging system according to claim 7, wherein the treatment device is configured to perform at least one of a pressure washing process, an acid wash process, and a brushing process.

9. The photo imaging system according to claim 1, further comprising a surface priming device configured to apply, via one of a brushing and spraying process, a primer to the printing surface area of the porous material.

10. The photo imaging system according to claim 1, further comprising a base coat applying device that is configured to apply, via one of a brushing and spraying process, a base coat of at least one of ink and paint to the printing surface area of the porous material.

11. The photo imaging system according to claim 1, further comprising a photo enhancement device that is configured to format the photo to fit the surface printing area of the porous material and configured to perform contrast and color saturation processes of the photo to produce correct color reproduction.

12. The photo imaging system according to claim 1, further comprising a preservation device that is configured to apply a coating, via one of a brushing and spraying process, to the printing surface area of the porous stone.

13. The photo imaging system according to claim 12, wherein the coating is an acrylic coating.

14. A method for forming an image in porous material, the method comprising:
supporting a porous material on a printing device configured to travel over the porous material for printing a photo thereon;
printing on a printing surface area of the porous material the photo; and
curing the printed photo with at least one curing device configured to travel over at least the printing surface area of the porous material.

15. The method according to claim 14, wherein the printing device includes at least one inkjet head that is configured to dispense ink of at least one color onto the printing surface area of the porous material.

16. The method according to claim 14, wherein the printing device includes a flatbed printer vacuum bed that is configured to support the porous material in a substantially fixed orientation with respect to the at least one inkjet head while the at least one inkjet head dispenses ink over the printing surface area of the porous material.

17. The method according to claim 14, wherein the at least one curing device includes at least one ultra violet (UV) light source including at least one shutter that is configured emit UV light up to 7500 watts.

18. The method according to claim 14, further comprising removing debris from the printing surface area of the porous material with a surface treatment device, and wherein removing debris from the printing surface area of the porous material comprises performing at least one of a pressure washing process, an acid wash process, and a brushing process.

19. The method according to claim 14, further comprising applying, via one of a brushing and spraying process, a primer to the printing surface area of the porous material with a surface priming device.

20. The method according to claim 14, further comprising applying, via one of a brushing and spraying process, a base coat of at least one of ink and paint to the printing surface area of the porous material with a base coat applying device.

21. The method according to claim 14, further comprising:
formatting with a photo enhancement device the photo to fit the surface printing area of the porous material; and
performing with the photo enhancement device contrast and color saturation processes of the photo to produce correct color reproduction.

22. The method according to claim 14, further comprising applying an acrylic coating, via one of a brushing and spraying process, to the printing surface area of the porous stone with a preservation device.
